(19) United States
(12) Patent Application Publication
(10) Pub. No.: US 2024/0249506 A1
(43) Pub. Date: Jul. 25, 2024

(54) SYSTEMS AND METHODS FOR PROCESSING IMAGES CAPTURED AT A PRODUCT STORAGE FACILITY

(71) Applicant: WALMART APOLLO, LLC, BENTONVILLE, AR (US)

(72) Inventors: Ishan Arora, Bangalore (IN); Raghava Balusu, Achanta (IN); Avi Raj, Buxar (IN); Abhinav Pachauri, Kanpur (IN); Han Zhang, Plano, TX (US); Mingquan Yuan, Flower Mound, TX (US); Avinash M. Jade, Bangalore (IN); Lingfeng Zhang, Dallas, TX (US); Srinivas Muktevi, Bengaluru (IN); Amit Jhunjhunwala, Bangalore (IN); Siddhartha Chakraborty, KOLKATA (IN)

(21) Appl. No.: 18/158,950

(22) Filed: Jan. 24, 2023

(51) Int. Cl. G06V 10/774; G06V 10/762; G06V 10/764; G06V 10/776; G06V 10/94; G06V 20/70; G06V 30/19

(52) U.S. Cl. CPC G06V 10/774; G06V 10/762; G06V 10/764; G06V 10/776; G06V 10/945; G06V 20/70; G06V 30/19007; G06V 10/82

(57) ABSTRACT

In some embodiments, apparatuses and methods are provided herein useful to labeling objects in captured images. In some embodiments, there is provided a system for labeling objects in images captured at a product storage facility including a control circuit and a user interface. The control circuit is configured to select a set of unprocessed images; receive a selected configuration based on data resulting from iteratively processing the set of unprocessed images; cluster each unprocessed image into a corresponding group based on the selected configuration; select a plurality of clustered images from each of the plurality of groups; and output the plurality of clustered images from each group. The user interface is configured to: display each clustered image; and receive a user input labeling one or more objects shown in each clustered image resulting in a labeled dataset used to train a machine learning model.

This application is related to the following applications, each of which is incorporated herein by reference in its entirety: entitled SYSTEMS AND METHODS OF SELECTING AN IMAGE FROM A GROUP OF IMAGES OF A RETAIL PRODUCT STORAGE AREA filed on Oct. 11, 2022, application Ser. No. 17/963,787 (attorney docket No. 8842-154648-US_7074US01); entitled SYSTEMS AND METHODS OF IDENTIFYING INDIVIDUAL RETAIL PRODUCTS IN A PRODUCT STORAGE AREA BASED ON AN IMAGE OF THE PRODUCT STORAGE AREA filed on Oct. 11, 2022, application Ser. No. 17/963,802 (attorney docket No. 8842-154649-US_7075US01); entitled CLUSTERING OF ITEMS WITH HETEROGENEOUS DATA POINTS filed on Oct. 11, 2022, application Ser. No. 17/963,903 (attorney docket No. 8842-154650-US_7084US01); entitled SYSTEMS AND METHODS OF TRANSFORMING IMAGE DATA TO PRODUCT STORAGE FACILITY LOCATION INFORMATION filed on Oct. 11, 2022, application Ser. No. 17/963,751 (attorney docket No. 8842-155168-US_7108US01); entitled SYSTEMS AND METHODS OF MAPPING AN INTERIOR SPACE OF A PRODUCT STORAGE FACILITY filed on Oct. 14, 2022, application Ser. No. 17/966,580 (attorney docket No. 8842-155167-US_7109US01); entitled SYSTEMS AND METHODS OF DETECTING PRICE TAGS AND ASSOCIATING THE PRICE TAGS WITH PRODUCTS filed on Oct. 21, 2022, application Ser. No. 17/971,350 (attorney docket No. 8842-155164-US_7076US01); and entitled SYSTEMS AND METHODS OF VERIFYING PRICE TAG LABEL-PRODUCT PAIRINGS filed on Nov. 9, 2022, application Ser. No. 17/983,773 (attorney docket No. 8842-155448-US_7077US01); entitled SYSTEMS AND METHODS OF USING CACHED IMAGES TO DETERMINE PRODUCT COUNTS ON PRODUCT STORAGE STRUCTURES OF A PRODUCT STORAGE FACILITY filed Jan. 24, 2023, application Ser. No. ______ (attorney docket No. 8842-155761-US_7079US01); entitled METHODS AND SYSTEMS FOR CREATING REFERENCE IMAGE TEMPLATES FOR IDENTIFICATION OF PRODUCTS ON PRODUCT STORAGE STRUCTURES OF A RETAIL FACILITY filed Jan. 24, 2023, application Ser. No. ______ (attorney docket No. 8842-155764-US_7079US01); and entitled SYSTEMS AND METHODS FOR PROCESSING IMAGES CAPTURED AT A PRODUCT STORAGE FACILTY filed Jan. 24, 2023, application Ser. No. _______ (attorney docket No. 8842-155165-US_7085US01).

### TECHNICAL FIELD

This invention relates generally to recognition of objects in images, and more specifically to training machine learning models to recognize objects in images.

### BACKGROUND

A typical product storage facility (e.g., a retail store, a product distribution center, a warehouse, etc.) may have hundreds of shelves and thousands of products stored on the shelves or on pallets. It is common for workers of such product storage facilities to manually (e.g., visually) inspect or inventory product display shelves and/or pallet storage areas to determine which of the products are adequately stocked and which products are or will soon be out of stock and need to be replenished.

Given the very large number of product storage areas such as shelves, pallets, and other product displays at product storage facilities of large retailers, and the even larger number of products stored in the product storage areas, manual inspection of the products on the shelves/pallets by the workers is very time consuming and significantly increases the operations cost for a retailer, since these workers could be performing other tasks if they were not involved in manually inspecting the product storage areas.

### BRIEF DESCRIPTION OF THE DRAWINGS

Disclosed herein are embodiments of systems, apparatuses and methods pertaining to labeling objects in images captured at a product storage facility. This description includes drawings, wherein:

FIG. 1 is a diagram of an exemplary system of updating inventory of products at a product storage facility in accordance with some embodiments, depicting a front view of a product storage area storing groups of various individual products for sale and stored at a product storage facility;

FIG. 2 comprises a block diagram of an exemplary image capture device in accordance with some embodiments;

FIG. 3 is a functional block diagram of an exemplary computing device in accordance with some embodiments;

FIG. 4 illustrates a simplified block diagram of an exemplary system for labeling objects in images captured at a product storage facility in accordance with some embodiments;

FIG. 5 shows a flow diagram of an exemplary method of labeling objects in images captured at a product storage facility in accordance with some embodiments;

FIGS. 6A-6B illustrate exemplary clustering of images in accordance with some embodiments;

FIG. 7 shows a flow diagram of an exemplary method of labeling objects in images captured at a product storage facility in accordance with some embodiments;

FIG. 8 shows a flow diagram of an exemplary method of labeling objects in images captured at a product storage facility in accordance with some embodiments;

FIG. 9 illustrates an exemplary user interface in accordance with some embodiments;

FIG. 10 shows a flow diagram of an exemplary method of labeling objects in images captured at a product storage facility in accordance with some embodiments; and

FIG. 11 illustrates an exemplary system for use in implementing methods, techniques, devices, apparatuses, systems, servers, sources and labeling objects in images captured at a product storage facility, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for labeling objects in images captured at a product storage facility. In some embodiments, a system for labeling objects in images captured at a product storage facility includes a control circuit. In some embodiments, the control circuit selects a set of unprocessed images from a plurality of unprocessed images of objects captured at the product storage facility. Alternatively or in addition to, the control circuit receives a selected configuration based on data resulting from iteratively processing the set of unprocessed images based on one of, or a combination of two or more of, a pretrained model, a feature extraction layer of the pretrained model, and a type of clustering. Alternatively or in addition to, the control circuit clusters each unprocessed image of the plurality of unprocessed images into a corresponding group of a plurality of groups based on the selected configuration. Alternatively or in addition to, the control circuit selects a plurality of clustered images from each of the plurality of groups. Alternatively or in addition to, the control circuit outputs the plurality of clustered images from each group. In some embodiments, the system includes a user interface operable on an electronic device. In some embodiments, the user interface displays each of the plurality of clustered images. Alternatively or in addition to, the user interface receives a user input labeling one or more objects shown in each of the plurality of clustered images resulting in a labeled dataset comprising a set of labeled images. Alternatively or in addition to, the control circuit trains a machine learning model based on the labeled dataset

In some embodiments, a method for labeling objects in images captured at a product storage facility includes selecting, by a control circuit, a set of unprocessed images from a plurality of unprocessed images of objects captured at the product storage facility. Alternatively or in addition to, the method includes receiving, by the control circuit, a selected configuration based on data resulting from iteratively processing the set of unprocessed images based on one of or a combination of two or more of a pretrained model, a feature extraction layer of the pretrained model, or a type of clustering. Alternatively or in addition to, the method includes clustering, by the control circuit, each unprocessed image of the plurality of unprocessed images into a corresponding group of a plurality of groups based on the selected configuration. Alternatively or in addition to, the method includes selecting, by the control circuit, a plurality of clustered images from each of the plurality of groups. Alternatively or in addition to, the method includes outputting, by the control circuit, the plurality of clustered images from each group. Alternatively or in addition to, the method includes displaying, by a user interface operable on an electronic device, each of the plurality of clustered images. Alternatively or in addition to, the method includes receiving, by the user interface, a user input labeling one or more objects shown in each of the plurality of clustered images resulting in a labeled dataset comprising a set of labeled images. Alternatively or in addition to, the method includes training, by the control circuit, a machine learning model based on the labeled dataset.

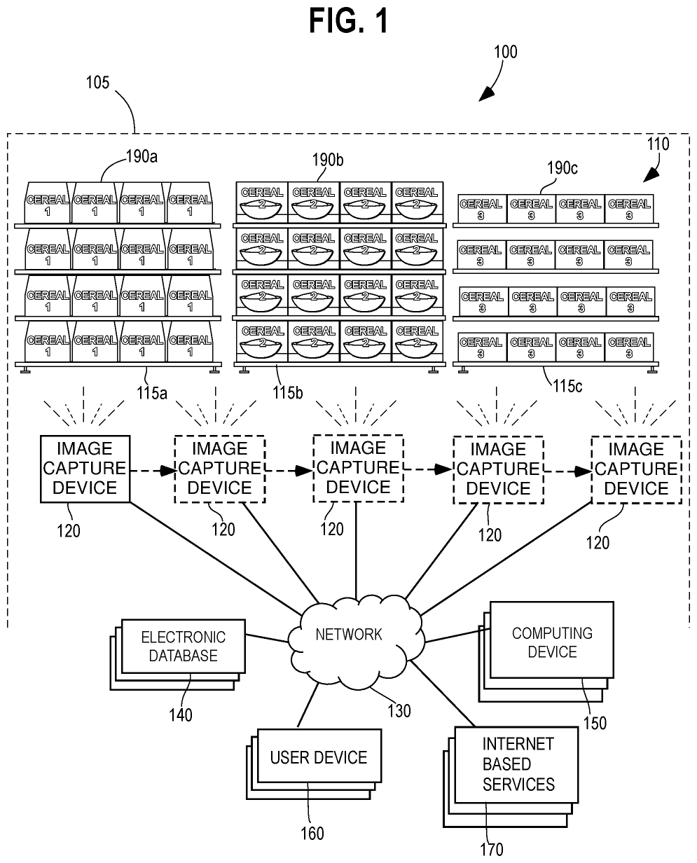

FIG. 1 shows an embodiment of a system 100 of updating inventory of products for sale and stored at product storage areas 110 and/or on product storage structures 115 of a product storage facility 105 (which may be a retail store, a product distribution center, a fulfillment center, a warehouse, etc.). The system 100 is illustrated in FIG. 1 for simplicity with only one movable image capture device 120 that moves about one product storage area 110 containing three separate product storage structures 115a, 115b, and 115c, but it will be appreciated that, depending on the size of the product storage facility, the system 100 may include multiple movable image capture devices 120 located throughout the product storage facility that monitor hundreds of product storage areas 110 and thousands of product storage structures 115a-115c. It is understood that the movement about the product storage area 110 by the image capture device(s) 120 may depend on the physical arrangement of the product storage area 110 and/or the size and shape of the product storage structure 115. For example, the image capture device 120 may move linearly down an aisle alongside a product storage structure 115 (e.g., a shelving unit), or may move in a circular fashion around a table having curved or multiple sides.

Notably, the term “product storage structure” as used herein generally refers to a structure on which products 190a-190c are stored, and may include a rack, a pallet, a shelf cabinet, a single shelf, a shelving unit, table, rack, displays, bins, gondola, case, countertop, or another product display. Likewise, it will be appreciated that the number of individual products 190a-190c representing three exemplary distinct products (labeled as “Cereal 1,” “Cereal 2,” and “Cereal 3”) is chosen by way of example only. Further, the size and shape of the products 190a-190c in FIG. have been shown by way of example only, and it will be appreciated that the individual products 190a-190c may have various sizes and shapes. Notably, the term products 190 may refer to individual products 190 (some of which may be single-piece/single-component products and some of which may be multi-piece/multi-component products), as well as to packages or containers of products 190, which may be plastic-or paper-based packaging that includes multiple units of a given product 190 (e.g., a plastic wrap that includes 36 rolls of identical paper towels, a paper box that includes 10 packs of identical diapers, etc.). Alternatively, the packaging of the individual products 190 may be a plastic-or paper-based container that encloses one individual product 190 (e.g., a box of cereal, a bottle of shampoo, etc.).

The image capture device 120 (also referred to as an image capture unit) of the exemplary system 100 depicted in FIG. 1 is configured to move around the product storage facility (e.g., on the floor via a motorized or non-motorized wheel-based/track-based locomotion system, via slidable tracks above the floor, via a toothed metal wheel/linked metal tracks system, etc.) such that, when moving (e.g., about an aisle or other area of a product storage facility 105), the image capture device 120 has a field of view that includes at least a portion of one or more of the product storage structures 115a-115c within a given product storage area 110 of the product storage facility 105, permitting the image capture device 120 to capture multiple images of the product storage area 110 from various viewing angles. In some embodiments, the image capture device 120 is configured as a robotic device that moves without being physically operated/manipulated by a human operator (as described in more detail below). In other embodiments, the image capture device 120 is configured to be driven or manually pushed (e.g., like a cart or the like) by a human operator. In still further embodiments, the image capture device 120 may be a hand-held or a wearable device (e.g., a camera, phone, tablet, or the like) that may be carried and/or work by a worker at the product storage facility 105 while the worker moves about the product storage facility 105. In some embodiments, the image capture device 120 may be incorporated into another mobile device (e.g., a floor cleaner, floor sweeper, forklift, etc.), the primary purpose of which is independent of capturing images of product storage areas 110 of the product storage facility 105.

In some embodiments, as will be described in more detail below, the images of the product storage area 110 captured by the image capture device 120 while moving about the product storage area are transmitted by the image capture device 120 over a network 130 to an electronic database 140 and/or to a computing device 150. In some aspects, the computing device 150 (or a separate image processing internet-based/cloud-based service module) is configured to process such images as will be described in more detail below.

The exemplary system 100 shown in FIG. 1 includes an electronic database 140. Generally, the exemplary electronic database 140 may be configured as a single database, or a collection of multiple communicatively connected databases (e.g., digital image database, meta data database, inventory database, pricing database, customer database, vendor database, manufacturer database, etc.) and is configured to store various raw and processed images of the product storage area 110 captured by the image capture device 120 while the image capture device 120 may be moving around the product storage facility 105. In some embodiments, the electronic database 140 and the computing device 150 may be implemented as two separate physical devices located at the product storage facility 105. It will be appreciated, however, that the computing device 150 and the electronic database 140 may be implemented as a single physical device and/or may be located at different (e.g., remote) locations relative to each other and relative to the product storage facility 105. In some aspects, the electronic database 140 may be stored, for example, on non-volatile storage media (e.g., a hard drive, flash drive, or removable optical disk) internal or external to the computing device 150, or internal or external to computing devices distinct from the computing device 150. In some embodiments, the electronic database 140 may be cloud-based. In some embodiments, the electronic database 140 may include one or more memory devices, computer data storage, and/or cloud-based data storage configured to store one or more of product inventories, pricing, and/or demand, and/or customer, vendor , and/or manufacturer data.

The system 100 of FIG. 1 further includes a computing device 150 configured to communicate with the electronic database 140, user devices 160, and/or internet-based services 170, and the image capture device 120 over the network 130. The exemplary network 130 depicted in FIG. 1 maybe a wide-area network (WAN), a local area network (LAN), a personal area network (PAN), a wireless local area network (WLAN), Wi-Fi, Zigbee, Bluetooth (e.g., Bluetooth Low Energy (BLE) network), or any other internet or intranet network, or combinations of such networks. Generally, communication between various electronic devices of system 100 may take place over hard-wired, wireless, cellular, Wi-Fi or Bluetooth networked components or the like. In some embodiments, one or more electronic devices of system 100 may include cloud-based features, such as cloud-based memory storage. In some embodiments, portions of the network 130 are located at or in the product storage facility.

The computing device 150 may be a stationary or portable electronic device, for example, a server, a cloud-server, a series of communicatively connected servers, a computer cluster, a desktop computer, a laptop computer, a tablet, a mobile phone, or any other electronic device including a control circuit (i.e., control unit) that includes a programmable processor. The computing device 150 may be configured for data entry and processing as well as for communication with other devices of system 100 via the network 130. As mentioned above, the computing device 150 may be located at the same physical location as the electronic database 140, or may be located at a remote physical location relative to the electronic database 140.

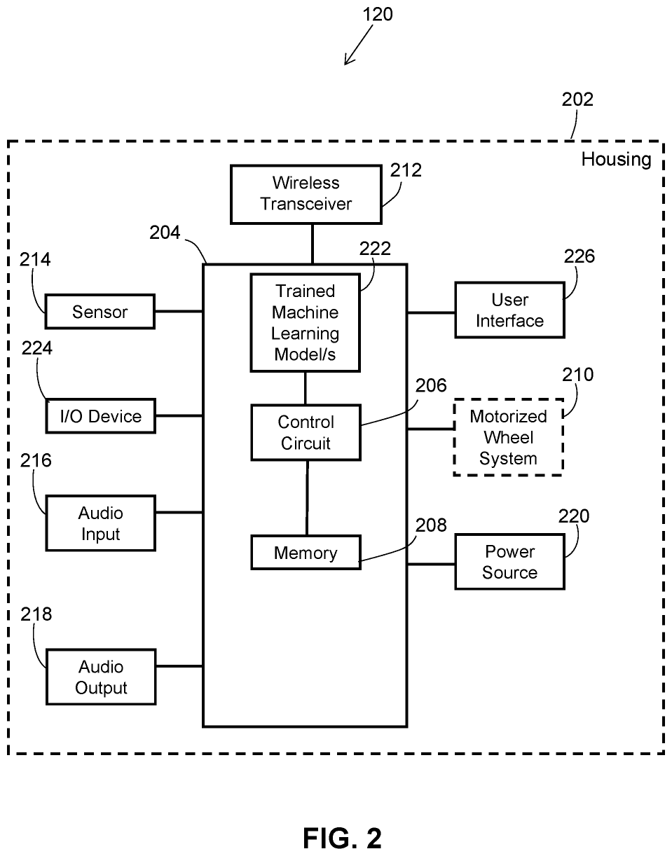

FIG. 2 presents a more detailed example of an exemplary motorized robotic image capture device 120. As mentioned above, the image capture device 102 does not necessarily need an autonomous motorized wheel-based and/or track-based system to move around the product storage facility 105, and may instead be moved (e.g., driven, pushed, carried, worn, etc.) by a human operator, or may be movably coupled to a track system (which may be above the floor level or at the floor level) that permits the image capture device 120 to move around the product storage facility 105 while capturing images of various product storage areas 110 of the product storage facility 105. In the example shown in FIG. 2, the motorized image capture device 120 has a housing 202 that contains (partially or fully) or at least supports and carries a number of components. These components include a control unit 204 comprising a control circuit 206 that controls the general operations of the motorized image capture device 120 (notably, in some implementations, the control circuit 310 of the computing device 150 may control the general operations of the image capture device 120). Accordingly, the control unit 204 also includes a memory 208 coupled to the control circuit 206 and that stores, for example, computer program code, operating instructions and/or useful data, which when executed by the control circuit implement the operations of the image capture device.

The control circuit 206 of the exemplary motorized image capture device 120 of FIG. 2, operably couples to a motorized wheel system 210, which, as pointed out above, is optional (and for this reason represented by way of dashed lines in FIG. 2). This motorized wheel system 210 functions as a locomotion system to permit the image capture device 120 to move within the product storage facility 105 (thus, the motorized wheel system 210 may be more generically referred to as a locomotion system). Generally, this motorized wheel system 210 may include at least one drive wheel (i.e., a wheel that rotates around a horizontal axis) under power to thereby cause the image capture device 120 to move through interaction with, e.g., the floor of the product storage facility. The motorized wheel system 210 can include any number of rotating wheels and/or other alternative floor-contacting mechanisms (e.g., tracks, etc.) as may be desired and/or appropriate to the application setting.

The motorized wheel system 210 may also include a steering mechanism of choice. One simple example may comprise one or more wheels that can swivel about a vertical axis to thereby cause the moving image capture device 120 to turn as well. It should be appreciated the motorized wheel system 210 may be any suitable motorized wheel and track system known in the art capable of permitting the image capture device 120 to move within the product storage facility 105. Further elaboration in these regards is not provided here for the sake of brevity save to note that the aforementioned control circuit 206 is configured to control the various operating states of the motorized wheel system 210 to thereby control when and how the motorized wheel system 210 operates.

In the exemplary embodiment of FIG. 2, the control circuit 206 operably couples to at least one wireless transceiver 212 that operates according to any known wireless protocol. This wireless transceiver 212 can comprise, for example, a Wi-Fi-compatible and/or Bluetooth-compatible transceiver (or any other transceiver operating according to known wireless protocols) that can wirelessly communicate with the aforementioned computing device 150 via the aforementioned network 130 of the product storage facility. So configured, the control circuit 206 of the image capture device 120 can provide information to the computing device 150 (via the network 130) and can receive information and/or movement instructions (instructions from the computing device 150. For example, the control circuit 206 can receive instructions from the computing device 150 via the network 130 regarding directional movement (e.g., specific predetermined routes of movement) of the image capture device 120 throughout the space of the product storage facility 105. These teachings will accommodate using any of a wide variety of wireless technologies as desired and/or as may be appropriate in a given application setting. These teachings will also accommodate employing two or more different wireless transceivers 212, if desired.

In the embodiment illustrated in FIG. 2, the control circuit 206 also couples to one or more on-board sensors 214 of the image capture device 120. These teachings will accommodate a wide variety of sensor technologies and form factors. According to some embodiments, the image capture device 120 can include one or more sensors 214 including but not limited to an optical sensor, a photo sensor, an infrared sensor, a 3-D sensor, a depth sensor, a digital camera sensor, a mobile electronic device (e.g., a cell phone, tablet, or the like), a quick response (QR) code sensor, a radio frequency identification (RFID) sensor, a near field communication (NFC) sensor, a stock keeping unit (SKU) sensor, a barcode (e.g., electronic product code (EPC), universal product code (UPC), European article number (EAN), global trade item number (GTIN)) sensor, or the like.

By one optional approach, an audio input 216 (such as a microphone) and/or an audio output 218 (such as a speaker) can also operably couple to the control circuit 206. So configured, the control circuit 206 can provide a variety of audible sounds to thereby communicate with workers at the product storage facility or other motorized image capture devices 120 moving around the product storage facility 105. These audible sounds can include any of a variety of tones and other non-verbal sounds. Such audible sounds can also include, in lieu of the foregoing or in combination therewith, pre-recorded or synthesized speech.

The audio input 216, in turn, provides a mechanism whereby, for example, a user (e.g., a worker at the product storage facility 105) provides verbal input to the control circuit 206. That verbal input can comprise, for example, instructions, inquiries, or information. So configured, a user can provide, for example, an instruction and/or query (e.g., where is pallet number so-and-so?, how many products are stocked on pallet number so-and-so? etc.) to the control circuit 206 via the audio input 216.

In the embodiment illustrated in FIG. 2, the motorized image capture device 120 includes a rechargeable power source 220 such as one or more batteries. The power provided by the rechargeable power source 220 can be made available to whichever components of the motorized image capture device 120 require electrical energy. By one approach, the motorized image capture device 120 includes a plug or other electrically conductive interface that the control circuit 206 can utilize to automatically connect to an external source of electrical energy to thereby recharge the rechargeable power source 220.

In some embodiments, the motorized image capture device 120 includes an input/output (I/O) device 224 that is coupled to the control circuit 206. The I/O device 224 allows an external device to couple to the control unit 204. The function and purpose of connecting devices will depend on the application. In some examples, devices connecting to the I/O device 224 may add functionality to the control unit 204, allow the exporting of data from the control unit 206, allow the diagnosing of the motorized image capture device 120, and so on.

In some embodiments, the motorized image capture device 120 includes a user interface 224 including for example, user inputs and/or user outputs or displays depending on the intended interaction with the user (e.g., worker at the product storage facility 105). For example, user inputs could include any input device such as buttons, knobs, switches, touch sensitive surfaces or display screens, and so on. Example user outputs include lights, display screens, and so on. The user interface 224 may work together with or separate from any user interface implemented at an optional user interface unit or user device 160 (such as a smart phone or tablet device) usable by a worker at the product storage facility. In some embodiments, the user interface 224 is separate from the image capture device 202, e.g., in a separate housing or device wired or wirelessly coupled to the image capture device 202. In some embodiments, the user interface may be implemented in a mobile user device 160 carried by a person and configured for communication over the network 130 with the image capture device 102.

In some embodiments, the motorized image capture device 120 may be controlled by the computing device 150 or a user (e.g., by driving or pushing the image capture device 120 or sending control signals to the image capture device 120 via the user device 160) on-site at the product storage facility 105 or off-site. This is due to the architecture of some embodiments where the computing device 150 and/or user device 160 outputs the control signals to the motorized image capture device 120. These controls signals can originate at any electronic device in communication with the computing device 150 and/or motorized image capture device 120. For example, the movement signals sent to the motorized image capture device 120 may be movement instructions determined by the computing device 150; commands received at the user device 160 from a user; and commands received at the computing device 150 from a remote user not located at the product storage facility 105.

In the embodiment illustrated in FIG. 2, the control unit 204 includes a memory 208 coupled to the control circuit 206 and that stores, for example, computer program code, operating instructions and/or useful data, which when executed by the control circuit implement the operations of the image capture device. The control circuit 206 can comprise a fixed-purpose hard-wired platform or can comprise a partially or wholly programmable platform. These architectural options are well known and understood in the art and require no further description here. This control circuit 206 is configured (for example, by using corresponding programming stored in the memory 208 as will be well understood by those skilled in the art) to carry out one or more of the steps, actions, and/or functions described herein. The memory 208 may be integral to the control circuit 206 or can be physically discrete (in whole or in part) from the control circuit 206 as desired. This memory 208 can also be local with respect to the control circuit 206 (where, for example, both share a common circuit board, chassis, power supply, and/or housing) or can be partially or wholly remote with respect to the control circuit 206. This memory 208 can serve, for example, to non-transitorily store the computer instructions that, when executed by the control circuit 206, cause the control circuit 206 to behave as described herein.

In some embodiments, the control circuit 206 may be communicatively coupled to one or more trained computer vision/machine learning/neural network modules 222 to perform at some of the functions. For example, the control circuit 206 may be trained to process one or more images of product storage areas 110 at the product storage facility 105 to detect and/or recognize one or more products 190 using one or more machine learning algorithms, including but not limited to Linear Regression, Logistic Regression, Decision Tree, SVM, Naïve Bayes, kNN, K-Means, Random Forest, Dimensionality Reduction Algorithms, Gradient Boosting Algorithms, Convolutional Neural Network (CNN), Recurrent Neural Network (RNN), Deep Neural Network (DNN), and/or algorithms associated with neural networks. In some embodiments, the trained machine learning model 222 includes a computer program code stored in a memory 208 and/or executed by the control circuit 206 to process one or more images, as described in more detail below.

It is noted that not all components illustrated in FIG. 2 are included in all embodiments of the motorized image capture device 120. That is, some components may be optional depending on the implementation of the motorized image capture device 120.

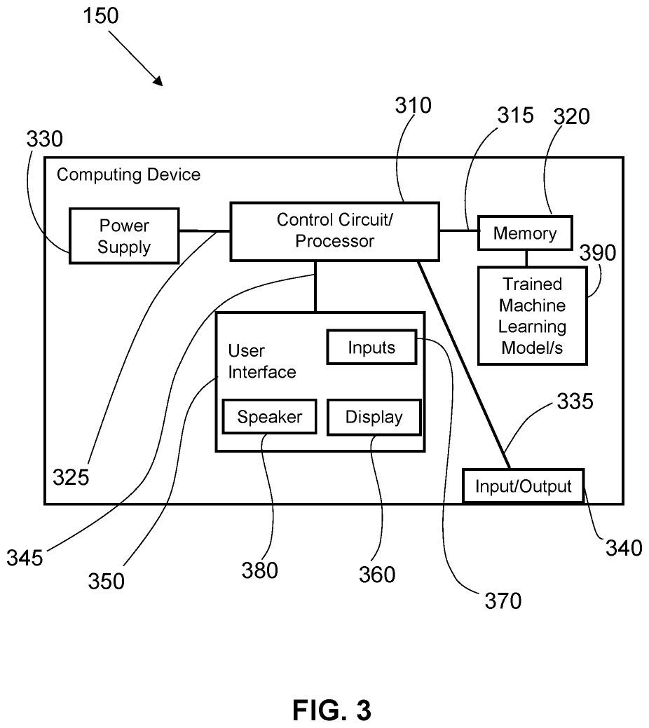

With reference to FIG. 3, the exemplary computing device 150 configured for use with exemplary systems and methods described herein may include a control circuit 310 including a programmable processor (e.g., a microprocessor or a microcontroller) electrically coupled via a connection 315 to a memory 320 and via a connection 325 to a power supply 330. The control circuit 310 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

The control circuit 310 can be configured (for example, by using corresponding programming stored in the memory 320 as will be well understood by those skilled in the art) to carry out one or more of the steps, actions, and/or functions described herein. In some embodiments, the memory 320 may be integral to the processor-based control circuit 310 or can be physically discrete (in whole or in part) from the control circuit 310 and is configured non-transitorily store the computer instructions that, when executed by the control circuit 310, cause the control circuit 310 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control unit may be referred to as a non-transitory medium or non-transitory computer readable medium.

The control circuit 310 of the computing device 150 is also electrically coupled via a connection 335 to an input/output 340 that can receive signals from, for example, from the image capture device 120, etc., the electronic database 140, internet-based services 170 (e.g., image processing services, computer vision services, neural network services, etc.), and/or from another electronic device (e.g., an electronic or user device of a worker tasked with physically inspecting the product storage area 110 and/or the product storage structures 115a-115c and observe the individual products 190a-190c stocked thereon. The input/output 340 of the computing device 150 can also send signals to other devices, for example, a signal to the electronic database 140 including an image of a given product storage structure 115b selected by the control circuit 310 of the computing device 150 as fully showing the product storage structure 115b and each of the products 190b stored in the product storage structure 115b. Also, a signal may be sent by the computing device 150 via the input-output 340 to the image capture device 120 to, for example, provide a route of movement for the image capture device 120 through the product storage facility.

The processor-based control circuit 310 of the computing device 150 shown in FIG. 3 maybe electrically or wirelessly coupled via a connection 345 to a user interface 350, which may include a visual display or display screen 360 (e.g., LED screen) and/or button input 370 that provide the user interface 350 with the ability to permit a user (e.g., worker at a the product storage facility 105 or a worker at a remote regional center) to access the computing device 150 by inputting commands via touch-screen and/or button operation and/or voice commands. Possible commands may for example, cause the computing device 150 to cause transmission of an alert signal to an electronic mobile user device 160 of a worker at the product storage facility 105 to assign a task to the worker that requires the worker to visually inspect and/or restock a given product storage structure 115a-115c based on analysis by the computing device 150 of the image of the product storage structure 115a-115c captured by the image capture device 120.

In some embodiments, the user interface 350 of the computing device 150 may also include a speaker 380 that provides audible feedback (e.g., alerts) to the operator of the computing device 150. It will be appreciated that the performance of such functions by the processor-based control circuit 310 of the computing device 150 is not dependent on a human operator, and that the control circuit 210 may be programmed to perform such functions without a human user.

As pointed out above, in some embodiments, the image capture device 120 moves around the product storage facility 105 (while being controlled remotely by the computing device 150 (or another remote device such as the user device 160), or while being controlled autonomously by the control circuit 206 of the image capture device 120), or while being manually driven or pushed by a worker of the product storage facility 105. When the image capture device 120 moves about the product storage area 110 as shown in FIG. 1, the sensor 214 of the image capture device 120, which may be one or more digital cameras, captures (in sequence) multiple images of the product storage area 110 from various angles. In some aspects, the control circuit 310 of the computing device 150 obtains (e.g., from the electronic database 140 or directly from the image capture device 120) the images of the product storage area 110 captured by the image capture device 120 while moving about the product storage area 110.

The sensor 214 (e.g., digital camera) of the image capture device 120 is located and/or oriented on the image capture device 120 such that, when the image capture device 120 moves about the product storage area 110, the field of view of the sensor 214 includes only portions of adjacent product storage structures 115a-115c, or an entire product storage structure 115a-115c. In certain aspects, the image capture device 120 is configured to move about the product storage area 110 while capturing images of the product storage structures 115a-115c at certain predetermined time intervals (e.g., every 1 second, 5 seconds, 10 seconds, etc.).

The images captured by the image capture device 120 may be transmitted to the electronic database 140 for storage and/or to the computing device 150 for processing by the control circuit 310 and/or to a web-/cloud-based image processing service 170. In some embodiments, one or more of the image capture devices 120 of the exemplary system 100 depicted in FIG. 1 is mounted on or coupled to a motorized robotic unit similar to the motorized robotic image capture device 120 of FIG. 2.

In some embodiments, one or more of the image capture devices 120 of the exemplary system 100 depicted in FIG. 1 is configured to be stationary or mounted to a structure, such that the image capture device 120 may capture one or more images of an area having one or more products at the product storage facility. For example, the area may include a product storage area 110, and/or a portion of and/or an entire product storage structures 115a-115c of the product storage facility.

In some embodiments, the electronic database 140 stores data corresponding to the inventory of products in the product storage facility. The control circuit 310 processes the images captured by the image capture device 120 and causes an update to the inventory of products in the electronic database 140. In some embodiments, one or more steps in the processing of the images are via machine learning and/or computer vision models that may include one or more trained neural network models. In certain aspects, the neural network may be a deep convolutional neural network. The neural network may be trained using various data sets, including, but not limited to: raw image data extracted from the images captured by the image capture device 120; metadata extracted from the images captured by the image capture device 120; reference image data associated with reference images of various product storage structures 115a-115c at the product storage facility; reference images of various products 190a-190c stocked and/or sold at the product storage facility; and/or planogram data associated with the product storage facility.

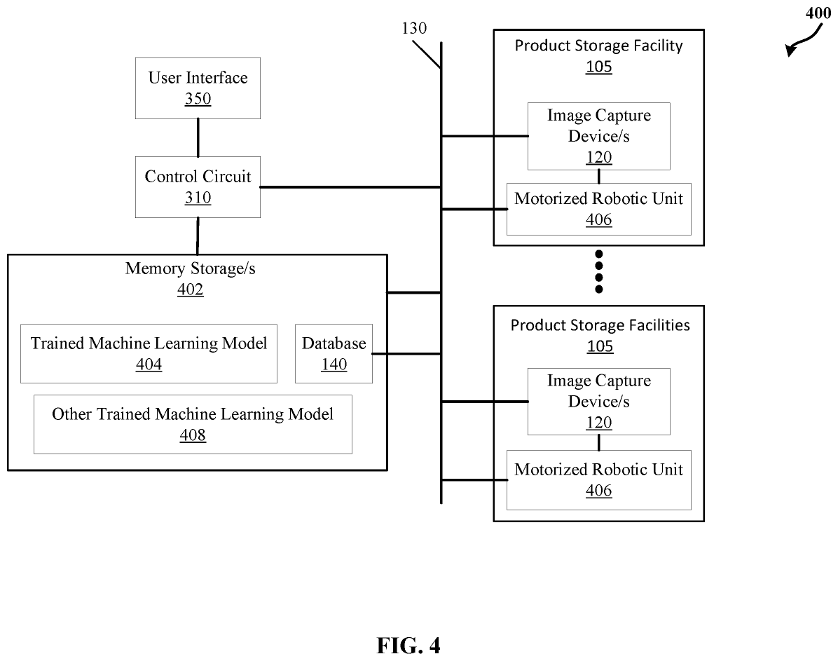

FIG. 4 illustrates a simplified block diagram of an exemplary system for labeling objects in images captured at at one or more product storage facilities in accordance with some embodiments. The system 400 includes a control circuit 310. Alternatively or in addition to, the system 400 may include memory storage/s 402, a user interface 350, and/or product storage facilities 105 coupled via a network 130. In some embodiments, the memory storage/s 402 may be one or more of a cloud storage network, a solid state drive, a hard drive, a random access memory (RAM), a read only memory (ROM), and/or any storage devices capable of storing electronic data, or any combination thereof. In some embodiments, the memory storage/s 402 includes the memory 320. In such an embodiment, a trained machine learning model 404 includes trained machine learning model/s 390. In some embodiments, the memory storage/s 402 is separate and distinct from the memory 320. In such an embodiment, the trained machine learning model 404 may be associated with the trained machine learning model/s 390. For example, the trained machine learning model/s 390 may be a copied version of the trained machine learning model 404. Alternatively or in addition to, the trained machine learning model 222 may be a copied version of the trained machine learning model 404. In some embodiments, the processing of unprocessed captured images is processed by the trained machine learning model 222.

In some embodiments, the memory storage/s 402 includes a trained machine learning model 404 and/or a database 140. In some embodiments, the database 140 may be an organized collection of structured information, or data, typically stored electronically in a computer system (e.g. the system 100). In some embodiments, the database 140 may be controlled by a database management system (DBMS). In some embodiments, the DBMS may include the control circuit 310. In yet some embodiments, the DBMS may include another control circuit (not shown) separate and/or distinct from the control circuit 310.

In some embodiments, the control circuit 310 may be communicatively coupled to the trained machine learning model 404 including one or more trained computer vision/machine learning/neural network modules to perform at some or all of the functions described herein. For example, the control circuit 310 using the trained machine learning model 404 may be trained to process one or more images of product storage areas (e.g., aisles, racks, shelves, pallets, to name a few) at product storage facilities 105 to detect and/or recognize one or more products for purchase using one or more machine learning algorithms, including but not limited to Linear Regression, Logistic Regression, Decision Tree, SVM, Naïve Bayes, kNN, K-Means, Random Forest, Dimensionality Reduction Algorithms, Gradient Boosting Algorithms, Convolutional Neural Network (CNN), Recurrent Neural Network (RNN), Deep Neural Network (DNN), and/or algorithms associated with neural networks. In some embodiments, the trained machine learning model 404 includes a computer program code stored in the memory storage/s 402 and/or executed by the control circuit 310 to process one or more images, as described herein.

The product storage facility 105 may include one of a retail store, a distribution center, and/or a fulfillment center. In some embodiments, a user interface 350 includes an application stored in a memory (e.g., the memory 320 or the memory storage/s 402) and executable by the control circuit 310. In some embodiments, the user interface 350 may be coupled to the control circuit 310 and may be used by a user to at least one of associate a product with at least one depicted object in processed images or resolve that one or more objects depicted in the images is only associated with a single product. In some embodiments, an output of the user interface 350 is used to retrain the trained machine learning model 404.

In some embodiments, the trained machine learning model 404 processes unprocessed captured images. For example, unprocessed captured images may include images captured by and/or output by the image capture device/s 120. Alternatively or in addition to, the unprocessed captured images may include images that have not gone through object detection or object classification by the control circuit 310. In some embodiments, at least some of the unprocessed captured images depict objects in the product storage facility 105.

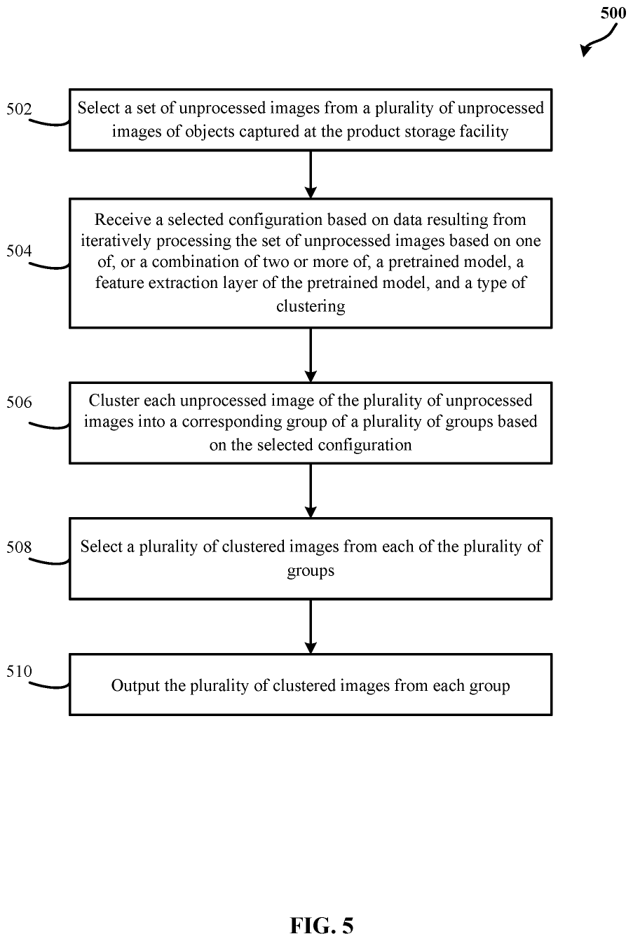

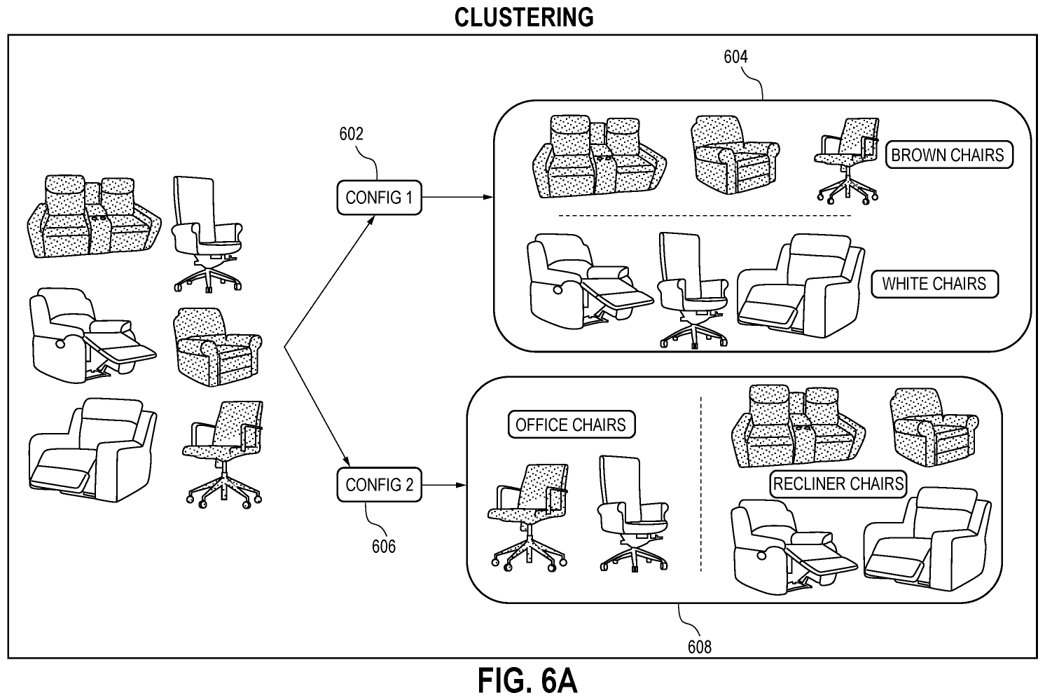

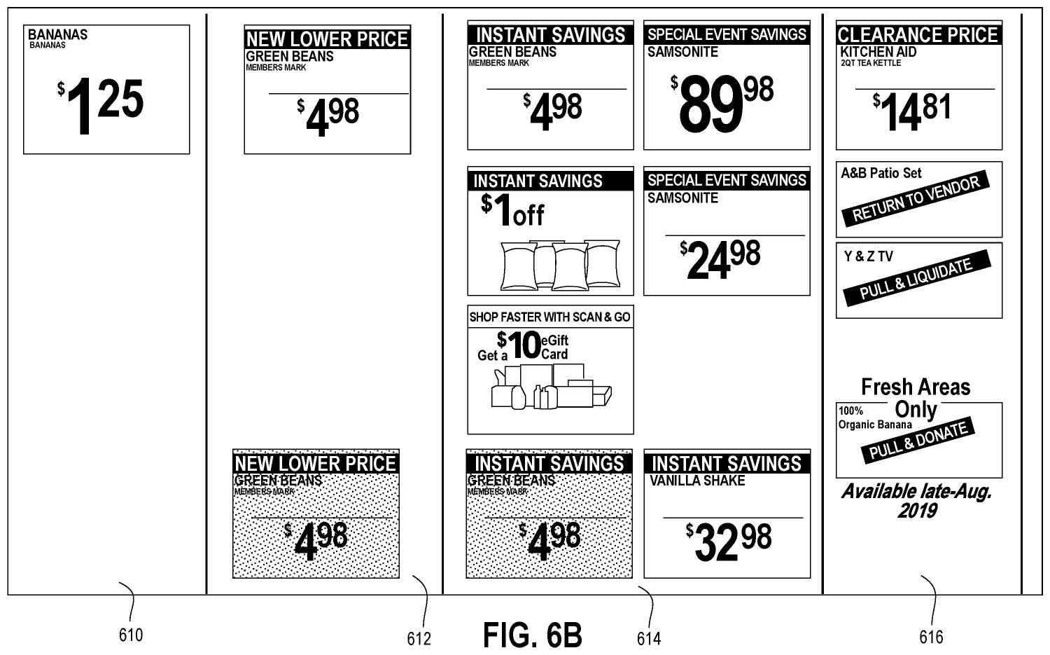

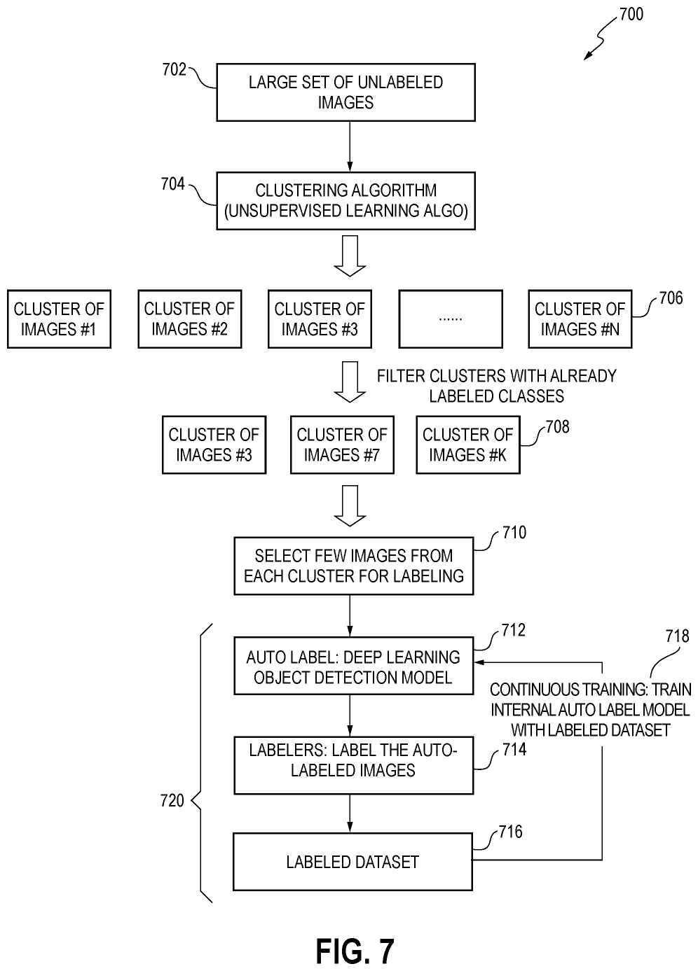

FIGS. 5 through 7 are concurrently described below. FIG. 5 shows a flow diagram of an exemplary method 500 of labeling objects in images captured at a product storage facility in accordance with some embodiments. FIGS. 6A-6B illustrate exemplary clustering of images in accordance with some embodiments. FIG. 7 shows a flow diagram of an exemplary method 700 of labeling objects in images captured at a product storage facility in accordance with some embodiments.

In an illustrative non-limiting example, the control circuit 310, at step 502, selects a set of unprocessed images from a plurality of unprocessed images of objects captured at the product storage facility 105. For example, one or more image capture devices 120 may capture the plurality of unprocessed images of objects at the product storage facility 105. In some embodiments, objects include items for sale and/or price tags. Alteratively or in addition to, a database 140 may store the plurality of unprocessed images. In yet some embodiments, at least one of the one or more image capture devices 120 is coupled to a motorized robotic unit 406.

Alteratively or in addition to, the control circuit 310, at step 504, receives a selected configuration based on data resulting from iteratively processing the set of unprocessed images based on one of, or a combination of two or more of, a pretrained model, a feature extraction layer of the pretrained model, and a type of clustering. In some embodiments, the pretrained model, the feature extraction layer of the pretrained model, and the type of clustering are example parameters that may be used to determine the selected configuration for clustering objects in images. In some embodiments, the trained machine learning model 404 may iteratively process the set of unprocessed images and/or provide the selected configuration. Alteratively or in addition to, a user via the user interface 350 may iteratively process the set of unprocessed images and/or provide the selected configuration. In an illustrative non-limiting example, a user may select from a list of pretrained models. For example, a pretrained model may include Resnet, EfficientNet, Vgg19, to name a few. In some embodiments, a pretrained model is a machine learning model that was previously trained to recognize general classes of objects (e.g., chairs, general price tags, trucks, shelves, pallets, bottles, cans, and boxes, to name a few). In another example, a pretrained model may be publicly known and/or downloadable. In some embodiments, the feature extraction layer of a pretrained model may include one or more convolutional layers used to extract features and/or patterns on images. For example, earlier or final layers of a pretrained convolutional neural network (CNN) may be used. In another example, the user may browse through the visual clustering output of all the convolutional layers or blocks. By one approach, the user may browse through the final layers (e.g., clustering is around objects like bike, car, etc.). By another approach, the user may browse through the initial layers (e.g., clustering is around low-level image features like color, texture, etc.). By another approach, the user may browse through the intermediate layers (e.g., clustering is around medium level image features, such as rainy, sunny images, etc.). In some embodiments, a type of clustering includes K-means, Graph based clustering using Louvain algorithm, to name a few. Resnet, EfficientNet, Vgg19, CNN, K-means, and Louvain algorithm are well known and understood in the field of artificial intelligence and require no further description here.

In an illustrative non-limiting example, a user via the user interface 350 may initiate processing of a set of unprocessed images randomly selected by the control circuit 310. In FIG. 6A, for example, the set of unprocessed images are various images of office chairs and recliners. By one approach, a user may select one of, or a combination of two or more of the following parameters: a pretrained model, a feature extraction layer of the pretrained model, and/or a type of clustering. For example, a user may initially select a first configuration 602 with the pretrained model as the parameter to process the set of unprocessed images. A first data 604 is the resulting output of processing the set of unprocessed images using the first configuration 602. The user may then subsequently select a second configuration 606 with the pretrained model and a particular type of clustering as the parameters used to process the same set of unprocessed images. A second data 608 is the resulting output of processing the same set of unprocessed images using the second configuration 606. Based on the data resulting from iteratively processing the same set of unprocessed images, the user may determine that the combination of the pretrained model and the particular type of clustering parameters (the second configuration 606) provides a better clustering of objects into a class or a group (e.g., brown chairs, white chairs, office chairs, and recliner chairs) relative to the clustering of objects using only the pretrained model (the first configuration 602).

Alteratively or in addition to, the control circuit 310, at step 506, may cluster each unprocessed image of the plurality of unprocessed images into a corresponding group of a plurality of groups based on the selected configuration. In another illustrative non-limiting example, FIG. 6B illustrates exemplary groups (e.g., a first group 610, a second group 612, a third group 614, and a fourth group 616) that resulted from processing images using various combinations of configuration parameters. For example, the particular configuration parameter that was selected to arrive at the second group 612 is good at grouping images of price tags that are textually similar. In another example, the particular configuration parameter that was selected to arrive at the third group 614 is good at grouping images of price tags indicating some price discounts or savings.

In another illustrative non-limiting example, different clustering approaches may be used based on the type of data. For example, pretrained/finetuned imagenet based CNN models may be used for visual features extraction of images followed by clustering using K-means.

Alteratively or in addition to, the control circuit 310, at step 508, may select a plurality of clustered images from each of the plurality of groups. For example, the selection of the plurality of clustered images from each of the plurality of groups may be randomly performed by the control circuit 310. Alteratively or in addition to, the control circuit 310, at step 510, may output the plurality of clustered images from each group. As such, the output represents a manageable set of representative sample of images. For example, the third group 614 includes a representative sample of images of price tags indicating some price discounts or savings.

In another illustrative non-limiting example, in FIG. 7, a large set of unlabeled images 702 (e.g., a plurality of unprocessed images) is input into a clustering algorithm 704 (e.g., an unsupervised learning algorithm). In some embodiments, the clustering algorithm 704 may run over a large set of unprocessed images and/or may select images from unique clusters as illustrated at 706. In some embodiments, the clustering algorithm may include a selected configuration based on data resulting from iterative processing of a set of unprocessed images based on one of, or a combination of two or more of, a pretrained model, a feature extraction layer of the pretrained model, and a type of clustering. In some embodiments, at 706, the control circuit 310 using the clustering algorithm may group each unlabeled image into a particular cluster. Alternatively or in addition to, at 708, the control circuit 310 may filter out clusters with already labeled images. For example, at 712, in processing the unlabeled images, the trained machine learning model 404 may label objects in the processed images. In an illustrative non-limiting example, in labeling an object in a processed image, the trained machine learning model 404 may enclose the object with a bounding box. Alternatively or in addition to, at 710, the control circuit 310 may select a few or a sample set of images from each cluster or remaining cluster for labeling.

In some embodiments, a user interface 350 operable on an electronic device (e.g., computing device 150) may display each of a plurality of clustered images. In an illustrative non-limiting example, representative images may be sampled from identified or selected clusters and/or sent for downstream labeling, thereby ensuring the data or image being labeled is diverse and/or does not have a lot of redundancy. For example, the selected few or sample set of images at 710 are displayed. Alternatively or in addition to, at 714, the user interface 350 may receive a user input labeling one or more objects shown in each of the plurality of clustered images resulting in a labeled dataset 716 including a set of labeled images. In some embodiments, the user interface 350 includes a graphical user interface used by a user to associate each of the objects shown in each of the plurality of clustered images to a corresponding product. In some embodiments, at 718, the control circuit 310 trains a machine learning model 404 based on the labeled dataset.

In some embodiments, at 720, the control circuit 310 subsequently selects a next plurality of clustered images from each of the plurality of groups. For example, the user interface 350 may display each of the next plurality of clustered images. Alternatively or in addition to, the user interface 350 may receive a next user input labeling one or more objects shown in each of the next plurality of clustered images resulting in next labeled dataset including a next set of labeled images. Alternatively or in addition to, the control circuit 310 may train the trained machine learning model 404 based on the next labeled dataset until a threshold number of labeled datasets have been used to train the trained machine learning model 404.

In some embodiments, the control circuit 310 selects a second plurality of clustered images from each of the plurality of groups. In some embodiments, at 712, automatically label using the trained machine learning model 404 one or more objects shown in each of the second plurality of clustered images resulting in automatically labeled set of images. Alternatively or in addition to, the user interface 350 may display each image of the automatically labeled set of images. In yet some embodiments, at 714, the user interface 350 receives a second user input relabeling mislabeled objects of the one or more objects shown in each of the second plurality of clustered images resulting in a correctly labeled set of images. In some embodiments, the control circuit 310 trains the trained machine learning model 404 based on the correctly labeled set of images.

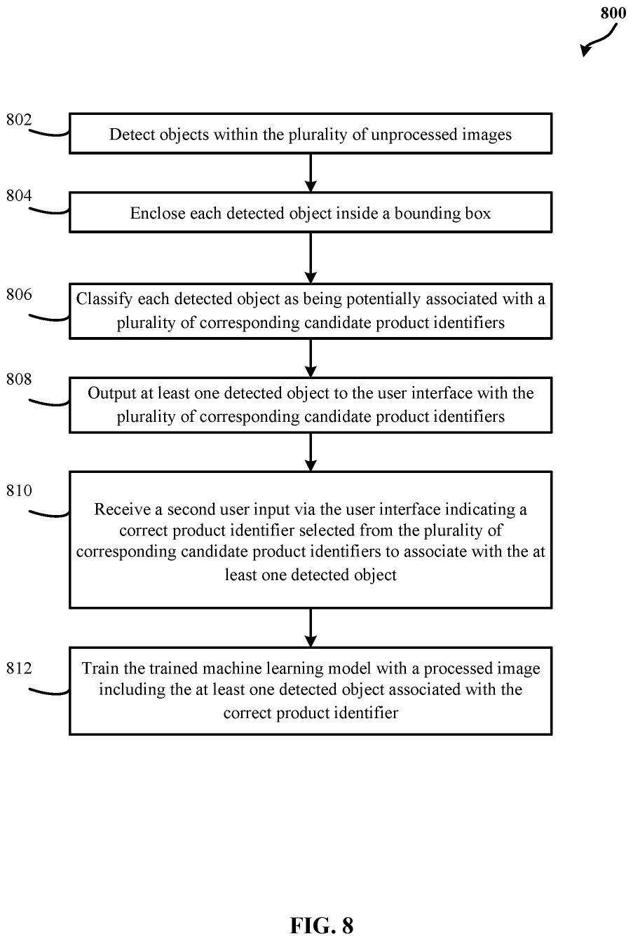

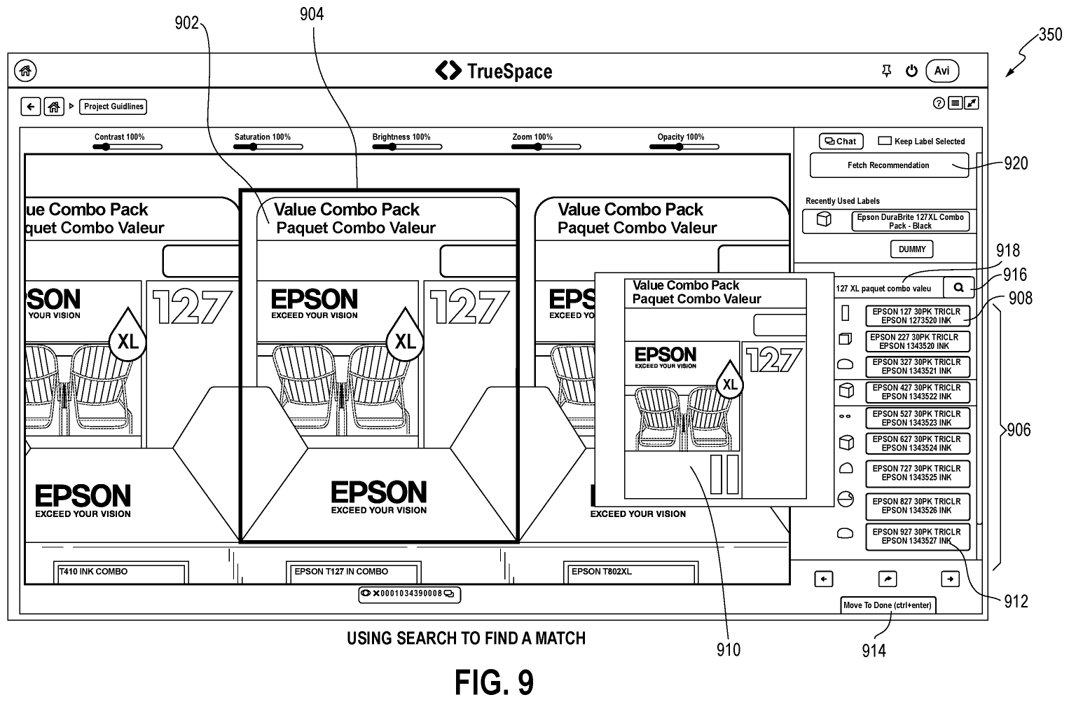

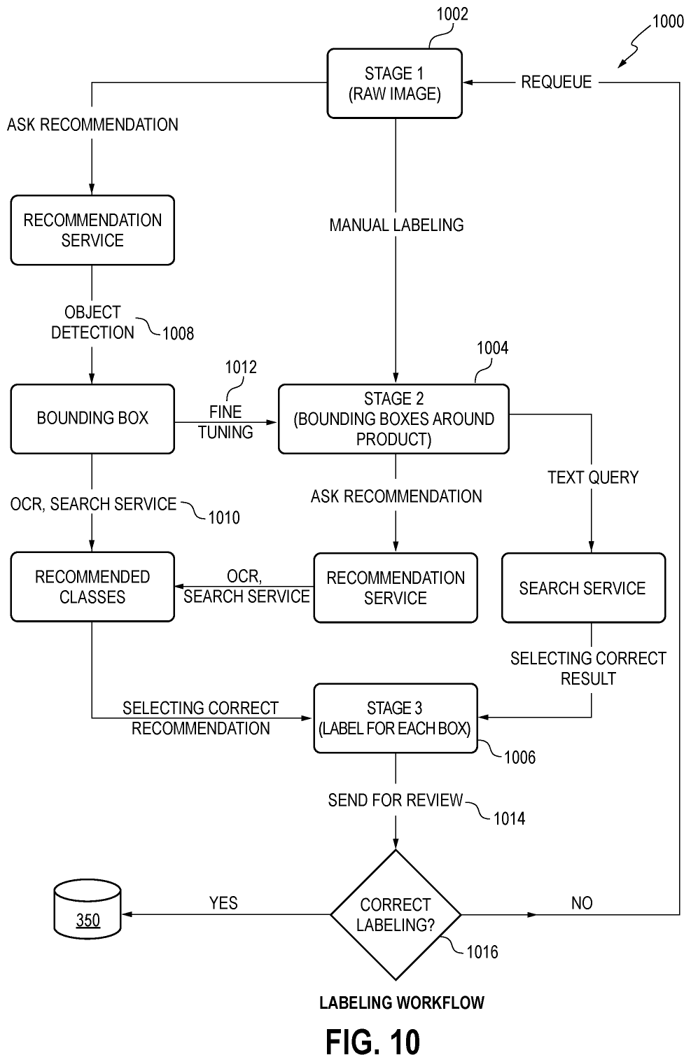

FIGS. 8 through 10 are concurrently described below. FIG. 8 shows a flow diagram of an exemplary method 800 of labeling objects in images captured at a product storage facility in accordance with some embodiments. FIGS. 9 illustrates an exemplary user interface in accordance with some embodiments. FIG. 10 shows a flow diagram of an exemplary method 1000 of labeling objects in images captured at a product storage facility in accordance with some embodiments.

In some embodiments, the labeling of auto-labeled images at step 714 of FIG. 7 can be performed on the user interface 350 as illustrated in FIG. 9. For example, the control circuit 310, at step 802, executing the trained machine learning model 404 may process a plurality of unprocessed images by detecting objects within the unprocessed images. Alternatively or in addition to, the control circuit 310 executing the trained machine learning model 404, at step 804, may process the unprocessed images by enclosing each detected object inside a bounding box 942. In some embodiments, object detection performed by the control circuit 310 may be executed using a known edge detection technique. A person of ordinary skilled in the art understands the various known methods and processing techniques in implementing edge detection when processing captured images. As such, further explanation of the edge detection technique is not necessary.

In an illustrative non-limiting example, the control circuit 310 may detect an object 902 on an image by enclosing the object 902 inside the bounding box 904 as shown in FIG. 9. Alternatively or in addition to, at step 806, the control circuit 310 may process the unprocessed images by classifying each detected object as being potentially associated with a plurality of corresponding candidate product identifiers 906. For example, the object 902 is classified by the trained machine learning model 404 as being one of the listed plurality of corresponding candidate product identifiers 906. In some embodiments, the order of the listing of the corresponding candidate product identifiers 906 indicates either increasing or decreasing likelihood or probability that a candidate product identifier 906 corresponds to the object 902. In some embodiments, the control circuit 310, at step 808, may output and/or caused at least one detected object to be displayed on the user interface 350 along with a listing of potential corresponding candidate product identifiers 906. In some embodiments, a user may select a first item 908 in the list. In some embodiments, the control circuit 310 and/or the trained machine learning model 404 may estimate that the first item 908 has the highest likelihood among the others on the list of being a match with the object 902 (i.e., a match indicates that the object is associated with the candidate product identifier). In yet some embodiments, the control circuit 310 and/or the trained machine learning model 404 may estimate that a last item 912 has the highest likelihood of being a match with the object 902.

Continuing the example above, an image 910 may be displayed once an item on the list is selected (e.g., once the first item 908, the last item 912, or one of the in-between item is selected).The user may then compare whether the object 902 matches with the image 910. By one approach, if they match, a user may click on a first button 914 to indicate a match. Alternatively or in addition to, the control circuit 310, at step 810, may receive a second user input via the user interface 350 indicating that a correct product identifier has been selected from the plurality of corresponding candidate product identifiers 906 to associate with at least one detected object (e.g., the object 902). When a product identifier has been associated with a detected object, the control circuit 310 and/or the trained machine learning model 404 may determine that the detected object and/or the image the detected object is depicted has been labeled and/or the image has been processed. By another approach, if they do not match, the user may then move on to the next one on the list to again compare if there is a match.

In some embodiments, if there is not a match in the listing, the user may perform a manual search by entering one or more terms in a search field 918 and clicking/selecting a second button 916. In such an approach, the control circuit 310 and/or the trained machine learning model 404 may access the database 140 to search for a potential match of the entered one or more terms with one or more stored product details. In some embodiments, each potential match may be associated with a probability value based on the search term that was matched and/or the weight associated with or assigned with the corresponding product or database field the matched term is found. Once the potential matches are found, the control circuit 310 and/or the trained machine learning model 404 may update the listed plurality of corresponding candidate product identifiers 906 with a new listing of corresponding candidate product identifiers 906. In some embodiments, the user may then go through the new listing to identify a matching candidate product identifier 906 with the object 902. In some embodiments, the user may perform multiple manual searches until a match is found. The control circuit 310, at step 812, may then train the trained machine learning model 404 with the processed image including the detected object associated with the correct product identifier.

In an illustrative non-limiting example, a text search may be performed against a cognitive search index (e.g., Azure), which is used as a source of class while labeling. In some embodiments, the database 140 includes the cognitive search index. The database 140 may store product details, such as product name, brand, description, sample image, text extracted from sample image, to name a few. In some embodiments, each product detail is stored in a corresponding database field. Each database field may be associated with a weight. The weights associated with the database fields may be tuned for optimum search result. For example, the weights may be tuned by gathering data via a survey and using a machine learning algorithm (e.g., the trained machine learning model 404, the other trained machine learning model 408, Linear regression, logistic regression, decision tree, artificial neural network, k-Nearest Neighbors, k-Means, Gradient Descent Algorithm, to name a few) to tune relative weights. In an illustrative non-limiting example, in the survey, humans may be asked to provide a relevance score against a search string. Using this data, the gradient descent algorithm may tune the relative weights on test data and get the best scoring profile in order to identify which database fields are more important for relevant results (for example, productName may be more important than product attribute). In some embodiments, a search query may display a predetermined or preselected number of results (e.g., a listing of 10 candidate product identifiers 906) from the index having the ten highest search scores (e.g., corresponding candidate product identifiers that have the top 10 highest probability values) with corresponding product names and sample images for easy comparison as exemplified in FIG. 9.

Another illustrative non-limiting example is illustrated in FIG. 10. In some embodiments, the labeling of objects in a captured image at a product storage facility by the control circuit 310 and/or the trained machine learning model 404 may include 3 stages (e.g., a first stage 1002, a second stage 1004, and a third stage 1006). In some embodiments, the first stage 1002 includes receiving of or accessing raw image (e.g., unprocessed images) from the database 140.

Alternatively or in addition to, the control circuit 310 and/or the trained machine learning model 404 may perform object detection 1008 on the raw image and/or object classification 1010 during the second stage 1004. In some embodiments, the unprocessed images or the raw images are images that may have not gone through objection detection 1008 or object classification 1010 by the control circuit 310. In some embodiments, the control circuit 310 may use another/other trained machine learning model 408 to detect the objects and enclose each detected object inside the bounding box. The other trained machine learning model 408 may be distinct from the trained machine learning model 404.

In some embodiments, implementation of the object detection 1008 mayinclude augmenting the raw image with one or more bounding boxes to indicate that objects inside the bounding boxes have been detected. Alternatively or in addition to, a user may manually select an item on the image to indicate to the control circuit 310 and/or the trained machine learning model 404 to place a bounding box on the item. In some embodiments, after the control circuit 310 and/or the trained machine learning model 404 perform the object detection 1008, the control circuit 310 and/or the trained machine learning model 404 may present or display on the user interface 350 the resulting processed images for additional fine tuning. In some embodiments, the control circuit 310 and/or the trained machine learning model 404 may randomly select one or more images of the processed images to output to the user interface 350 for additional fine tuning 1012. For example, additional fine tuning 1012 may include a user confirming that depicted objects on the image are bounded by boxes to indicate object detection. In an example where an object is incorrectly bounded and/or a bounding box was incorrectly placed on the image, the user may correct the processed image by correctly bounding the object and/or removing the incorrectly placed bounding box. Alternatively or in addition to, the user may select or click on fetch recommendation button 920 to indicate to the control circuit 310 and/or the trained machine learning model 404 to perform the object classification 1010.

In some embodiments, the object classification 1010 may include the use of known optical character recognition (OCR) technique. A person of ordinary skilled in the art understands the various known methods and processing techniques in implementing OCR when processing captured images. As such, further explanation of the OCR technique is not necessary. In some embodiments, implementation of the object classification 1010 enables the control circuit 310 and/or the trained machine learning model 404 to recognize the detected object (e.g., identifying the class that the detected object is associated with) by comparing the textual and/or visual similarity of the object with those images stored in the database 140.

To illustrate, the database 140 may store a plurality of processed images. Each processed image may show at least one object inside a bounding box indicating the at least one object has been detected in the processed image. In some embodiments, the database 140 may store text associated with corresponding product identifiers and/or a plurality of stored product images associated with the corresponding product identifiers. In some embodiments, the control circuit 310, in classifying each detected object as potentially associated with the plurality of corresponding candidate product identifiers, compares, using the trained machine learning model 404, detected text in a bounded object of a processed image with the text associated with the corresponding product identifiers to determine a first set of matches. For example, each match of the first set of matches may be associated with a first corresponding probability value and a first respective product identifier of the match. Alternatively or in addition to, the control circuit 310 may compare, using the trained machine learning model 404, one or more detected visual images of the bounded object with the plurality of stored product images to determine a second set of matches. Each match of the second set of matches may be associated with a second corresponding probability value and a second respective product identifier of the match. Alternatively or in addition to, the control circuit 310 may determine, using the trained machine learning model 404, a third set of matches. The third set of matches may be those matches in the first set of matches and the second set of matches that are associated with probability values that are greater than a threshold value. In some embodiments, the threshold value may be predetermined. For example, threshold values may lie within a range of 0 to 1. In such example, the threshold value may be tuned based on one or more use cases. For example, in one use case, the threshold value may comprise 0.5. In yet another use case, the threshold value may comprise 0.7.

Alternatively or in addition to, the control circuit 310 and/or the trained machine learning model 404 may determine that not a single probability value in the first set of matches and the second set of matches is greater than the threshold value. In some embodiments, the control circuit 310 and/or the trained machine learning model 404, at step 1014, may prompt a user to perform a review during the third stage 1006. In some embodiments, the control circuit 310 and/or the trained machine learning model 404 may receive a third user input via the user interface 350.

For example, the third user input may include one or more words or terms associated with the bounded object of the processed image. In some embodiments, the control circuit 310 and/or the trained machine learning model 404 may search for product identifiers in the database 140 that are associated with the bounded object using the third user input. Alternatively or in addition to, the control circuit 310 and/or the trained machine learning model 404 may output the product identifiers associated with the bounded object to the user interface 350.

For example, as previously illustrated in FIG. 9, the user may perform a manual search by entering one or more terms in a search field 918 and clicking/selecting a second button 916. In such an approach, the control circuit 310 and/or the trained machine learning model 404 may access the database 140 to search for a potential match of the entered one or more words or terms with one or more stored product details. In some embodiments, each potential match may be associated with a probability value based on the search term/word that was matched and/or the weight associated with or assigned with the corresponding product or database field the matched term/word is found. Once the potential matches are found, the control circuit 310 and/or the trained machine learning model 404 may update the listed plurality of corresponding candidate product identifiers 906 with a new listing of corresponding candidate product identifiers 906. Alternatively or in addition to, when the user identifies the correct product identifier from the new listing, the control circuit 310 and/or the trained machine learning model 404 may receive a fourth user input via the user interface 350 associating the correct product identifier with the bounded object. The correct product identifier may be selected from the new listing of candidate product identifiers 906. In response, the association of the correct product identifier with the bounded object may correspond to the labeling of the bounded object and/or the image the bounded object is depicted on. In some embodiments, the labeled bounded object and/or the image may be included in a labeled dataset used to train the trained machine learning model 404. For example, the control circuit 310 may train the trained machine learning model 404 with the processed image including the bounded object associated with the correct product identifier.

In some embodiments, in response to the control circuit 310 and/or the trained machine learning model 404, at step 1016, receiving a user input indicating that one or more images sent for a review have been correctly labeled, the one or more images are included in a labeled dataset stored in the database 350. In some embodiments, in response to receiving a user input indicating that one or more images sent for a review have been incorrectly labeled, the user may perform steps previously illustrated in FIG. 9, for example. In some embodiments, if the images sent for review are incorrectly labeled, a user input may be to requeue the image along with comments to correct the labels. Then that image may again go through the process of labeling where a user may either use the recommendation service or the manual labeling with the help of the search service. In some embodiments, after the user completes the labeling, the user may then again send it for review process at step 1014 of FIG. 10.

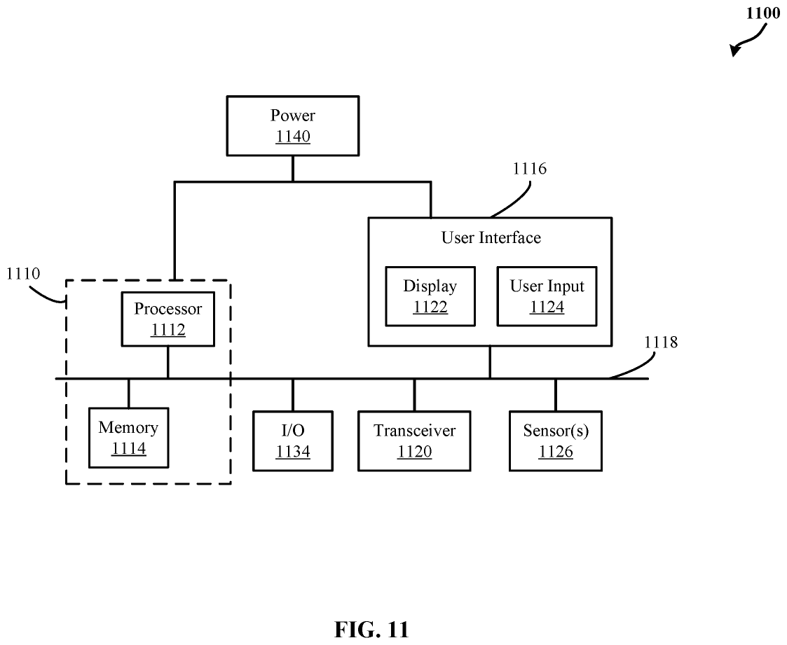

Further, the circuits, circuitry, systems, devices, processes, methods, techniques, functionality, services, servers, sources and the like described herein may be utilized, implemented and/or run on many different types of devices and/or systems. FIG. 11 illustrates an exemplary system 1100 that may be used for implementing any of the components, circuits, circuitry, systems, functionality, apparatuses, processes, or devices of the system 100 of FIG. 1, the movable image capture device 120 of FIG. 2, the computing device 150 of FIG. 3, the system 400 of FIG. 4, the method 500 of FIG. 5, the method 700 of FIG. 7, the method 800 of FIG. 8, the method 1000 of FIG. 10, and/or other above or below mentioned systems or devices, or parts of such circuits, circuitry, functionality, systems, apparatuses, processes, or devices. For example, the system 1000 may be used to implement some or all of the system for labeling objects in images captured at a product storage facility, the user interface 350, the control circuit 310, the memory storage/s 402, the database 140, the network 130, the image capture device/s 120 and the motorized robotic unit 406, and/or other such components, circuitry, functionality and/or devices. However, the use of the system 1100 or any portion thereof is certainly not required.

By way of example, the system 1100 maycomprise a processor module (or a control circuit) 1112, memory 1114, and one or more communication links, paths, buses or the like 1118. Some embodiments may include one or more user interfaces 1116, and/or one or more internal and/or external power sources or supplies 1140. The control circuit 112 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1112 can be part of control circuitry and/or a control system 1110, which may be implemented through one or more processors with access to one or more memory 1114 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 1100 maybe used to implement one or more of the above or below, or parts of, components, circuits, systems, processes and the like. For example, the system 1100 may implement the system for labeling objects in images captured at a product storage facility with the control circuit 310 being the control circuit 1112.

The user interface 1116 can allow a user to interact with the system 1100 and receive information through the system. In some instances, the user interface 1116 includes a display 1122 and/or one or more user inputs 1124, such as buttons, touch screen, track ball, keyboard, mouse, etc., which can be part of or wired or wirelessly coupled with the system 1100. Typically, the system 1100 further includes one or more communication interfaces, ports, transceivers 1120 and the like allowing the system 1100 to communicate over a communication bus, a distributed computer and/or communication network (e.g., a local area network (LAN), the Internet, wide area network (WAN), etc.), communication link 1118, other networks or communication channels with other devices and/or other such communications or combination of two or more of such communication methods. Further the transceiver 1120 can be configured for wired, wireless, optical, fiber optical cable, satellite, or other such communication configurations or combinations of two or more of such communications. Some embodiments include one or more input/output (I/O) interface 1134 that allow one or more devices to couple with the system 1100. The I/O interface can be substantially any relevant port or combinations of ports, such as but not limited to USB, Ethernet, or other such ports. The I/O interface 1134 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 1126 to provide information to the system and/or sensor information that is communicated to another component, such as the central control system, a portable retail container, a vehicle associated with the portable retail container, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 1100 comprises an example of a control and/or processor-based system with the control circuit 1112. Again, the control circuit 1112 can be implemented through one or more processors, controllers, central processing units, logic, software and the like. Further, in some implementations the control circuit 1112 mayprovide multiprocessor functionality.

The memory 1114, which can be accessed by the control circuit 1112, typically includes one or more processor readable and/or computer readable media accessed by at least the control circuit 1112, and can include volatile and/or nonvolatile media, such as RAM, ROM, EEPROM, flash memory and/or other memory technology. Further, the memory 1114 is shown as internal to the control system 1110; however, the memory 1114 can be internal, external or a combination of internal and external memory. Similarly, some or all of the memory 1114 can be internal, external or a combination of internal and external memory of the control circuit 1112. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 1114 can store code, software, executables, scripts, data, content, lists, programming, programs, log or history data, user information, customer information, product information, and the like. While FIG. 11 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for labeling objects in images captured at a product storage facility, the system comprising:
a control circuit configured to:
select a set of unprocessed images from a plurality of unprocessed images of objects captured at the product storage facility;
receive a selected configuration based on data resulting from iteratively processing the set of unprocessed images based on at least one of a pretrained model, a feature extraction layer of the pretrained model, and a type of clustering;
cluster each unprocessed image of the plurality of unprocessed images into a corresponding group of a plurality of groups based on the selected configuration;
select a plurality of clustered images from each of the plurality of groups; and
output the plurality of clustered images from each group; and
a user interface operable on an electronic device and configured to:
display each of the plurality of clustered images; and
receive a user input labeling one or more objects shown in each of the plurality of clustered images resulting in a labeled dataset comprising a set of labeled images,
wherein the control circuit is further configured to train a machine learning model based on the labeled dataset.

2. The system of claim 1, wherein the control circuit is further configured to subsequently select a next plurality of clustered images from each of the plurality of groups,
wherein the user interface is further configured to:
display each of the next plurality of clustered images; and
receive a next user input labeling one or more objects shown in each of the next plurality of clustered images resulting in next labeled dataset comprising a next set of labeled images; and
wherein the control circuit is further configured to train the trained machine learning model based on the next labeled dataset until a threshold number of labeled datasets have been used to train the trained machine learning model.

3. The system of claim 2, wherein the control circuit is further configured to:
select a second plurality of clustered images from each of the plurality of groups; and
automatically label using the trained machine learning model one or more objects shown in each of the second plurality of clustered images resulting in automatically labeled set of images,
wherein the user interface is further configured to:
display each image of the automatically labeled set of images; and
receive a second user input relabeling mislabeled objects of the one or more objects shown in each of the second plurality of clustered images resulting in a correctly labeled set of images; and
wherein the control circuit is further configured to train the trained machine learning model based on the correctly labeled set of images.

4. The system of claim 1, further comprising:
one or more image capture devices configured to capture the plurality of unprocessed images of objects at the product storage facility; and
a database configured to store the plurality of unprocessed images.

5. The system of claim 4, wherein at least one of the one or more image capture devices is coupled to a motorized robotic unit.

6. The system of claim 1, wherein the objects comprise items for sale and price tags.

7. The system of claim 1, wherein the user interface comprises a graphical user interface used by a user to associate each of the objects shown in each of the plurality of clustered images to a corresponding product.

8. The system of claim 1, wherein the control circuit is configured to:
process the plurality of unprocessed images by being configured to:
detect objects within the plurality of unprocessed images;
enclose each detected object inside a bounding box; and
classify each detected object as being potentially associated with a plurality of corresponding candidate product identifiers.

9. The system of claim 8, wherein the control circuit is further configured to:
output at least one detected object to the user interface with the plurality of corresponding candidate product identifiers;
receive a second user input via the user interface indicating a correct product identifier selected from the plurality of corresponding candidate product identifiers to associate with the at least one detected object; and
train the trained machine learning model with a processed image including the at least one detected object associated with the correct product identifier.

10. The system of claim 8, further comprising:
a database configured to store:
a plurality of processed images, wherein each processed image shows at least one object inside the bounding box indicating the at least one object has been detected in the processed image;
text associated with corresponding product identifiers; and
a plurality of stored product images associated with the corresponding product identifiers,
wherein the control circuit in classifying each detected object as potentially associated with the plurality of corresponding candidate product identifiers is further configured to:
compare, using the trained machine learning model, detected text in a bounded object of a processed image with the text associated with the corresponding product identifiers to determine a first set of matches, wherein each match of the first set of matches is associated with a first corresponding probability value and a first respective product identifier of the match;
compare, using the trained machine learning model, one or more detected visual images of the bounded object with the plurality of stored product images to determine a second set of matches, wherein each match of the second set of matches is associated with a second corresponding probability value and a second respective product identifier of the match; and
determine, using the trained machine learning model, a third set of matches, wherein the third set of matches are those matches in the first set of matches and the second set of matches that are associated with probability values that are greater than a threshold value.

11. The system of claim 10, wherein the control circuit is further configured to:
determine that not a single probability value in the first set of matches and the second set of matches is greater than the threshold value;
receive a third user input via the user interface, the third user input comprising one or more words associated with the bounded object of the processed image;
search product identifiers associated with the bounded object using the third user input;
output the product identifiers associated with the bounded object to the user interface;
receive a fourth user input via the user interface associating a correct product identifier selected from the product identifiers associated with the bounded object; and
train the trained machine learning model with a processed image including the bounded object associated with the correct product identifier.

12. The system of claim 8, wherein the control circuit uses another trained machine learning model to detect the objects and enclose each detected object inside the bounding box, and wherein the other trained machine learning model is distinct from the machine learning model.

13. The system of claim 8, wherein the plurality of unprocessed images are images that have not gone through objection detection or object classification by the control circuit.

14. A method for labeling objects in images captured at a product storage facility, the method comprising:
selecting, by a control circuit, a set of unprocessed images from a plurality of unprocessed images of objects captured at the product storage facility;
receiving, by the control circuit, a selected configuration based on data resulting from iteratively processing the set of unprocessed images based on at least one of a pretrained model, a feature extraction layer of the pretrained model, or a type of clustering;
clustering, by the control circuit, each unprocessed image of the plurality of unprocessed images into a corresponding group of a plurality of groups based on the selected configuration;
selecting, by the control circuit, a plurality of clustered images from each of the plurality of groups;
outputting, by the control circuit, the plurality of clustered images from each group;
displaying, by a user interface operable on an electronic device, each of the plurality of clustered images;
receiving, by the user interface, a user input labeling one or more objects shown in each of the plurality of clustered images resulting in a labeled dataset comprising a set of labeled images; and
training, by the control circuit, a machine learning model based on the labeled dataset.

15. The method of claim 14, further comprising:
selecting, by the control circuit, a next plurality of clustered images from each of the plurality of groups;
displaying, by the user interface, each of the next plurality of clustered images;
receiving, by the user interface, a next user input labeling one or more objects shown in each of the plurality of clustered images resulting in next labeled dataset comprising a next set of labeled images;
training, by the control circuit, the trained machine learning model based on the next labeled dataset until a threshold number of labeled datasets have been used to train the trained machine learning model.

16. The method of claim 15, further configured to:
selecting, by the control circuit, a second plurality of clustered images from each of the plurality of groups;
automatically labeling, by the control circuit using the trained machine learning model, the one or more objects shown in each of the plurality of clustered images resulting in automatically labeled set of images;
displaying, by the user interface, each image of the automatically labeled set of images;
receiving, by the user interface, a second user input relabeling mislabeled objects of the one or more objects shown in each of the second plurality of clustered images resulting in a correctly labeled set of images; and
training, by the control circuit, the trained machine learning model based on the correctly labeled set of images.

17. The method of claim 14, wherein the user interface comprises a graphical user interface used by a user to associate each of the objects shown in each of the plurality of clustered images to a corresponding product.

18. The method of claim 14, further comprising processing, by the control circuit, the plurality of unprocessed images by being configured to:
detecting objects within the plurality of unprocessed images;
enclosing each detected object inside a bounding box; and
classifying each detected object as being potentially associated with a plurality of corresponding candidate product identifiers.

19. The method of claim 18, further comprising:
outputting, by the control circuit, at least one detected object to the user interface with the plurality of corresponding candidate product identifiers;
receiving, by the control circuit, a second user input via the user interface indicating a correct product identifier selected from the plurality of corresponding candidate product identifiers to associate with the at least one detected object; and
training, by the control circuit, the trained machine learning model with a processed image including the at least one detected object associated with the correct product identifier.

20. The method of claim 19, further comprising:
storing, by a database, a plurality of processed images, wherein each processed image shows at least one object inside a bounding box indicating the at least one object has been detected in the processed image; text associated with corresponding product identifiers; and a plurality of stored product images associated with the corresponding product identifiers;
comparing, by the control circuit using the trained machine learning model, detected text in a bounded object of a processed image with the text associated with the corresponding product identifiers to determine a first set of matches, wherein each match of the first set of matches is associated with a first corresponding probability value and a first respective product identifier of the match;
comparing, by the control circuit using the trained machine learning model, one or more detected visual images of the bounded object with the plurality of stored product images to determine a second set of matches, wherein each match of the second set of matches is associated with a second corresponding probability value and a second respective product identifier of the match; and
determining, by the control circuit using the trained machine learning model, a third set of matches, wherein the third set of matches are those matches in the first set of matches and the second set of matches that are associated with probability values that are greater than a threshold value.
